(19) United States
(12) Patent Application Publication
(10) Pub. No.: US 2007/0214202 A1
(43) Pub. Date: Sep. 13, 2007

(54) Method and Apparatus for Efficient Data Acquisition and Interpolation

(76) Inventor: Gregory Beylkin, Boulder, CO (US)

Correspondence Address: BECK AND TYSVER P.L.L.C., 2900 THOMAS AVENUE SOUTH, SUITE 100, MINNEAPOLIS, MN, 55416, US

(21) Appl. No.: 10/582,575

(22) PCT Filed: Dec. 13, 2004
(86) PCT No.: PCT/US04/41863

§ 371 Date: Jan. 10, 2007

Related U.S. Application Data
(60) Provisional application No. 60/481,771, filed on Dec. 11, 2003.

(51) Int. Cl. G06F 17/17

(52) U.S. Cl. 708/290

(57) ABSTRACT

A method and apparatus for performing efficient interpolation of data sequences or signals is disclosed. A preferred embodiment of the present invention determines a suitable Gaussian quadrature to match given bandwidth and accuracy requirements. This Gaussian quadrature is then used to construct a suitable family of interpolating functions to represent a physical data sequence or signal (which, in a preferred embodiment, is seismic data). In one embodiment, Gaussian quadratures are constructed using trigonometric moments of exponential functions. In an alternative embodiment, an interpolating function is constructed using prolate spheroidal wave functions (PSWFs) by adopting Gaussian quadrature points corresponding to a family of PSWFs as interpolation points. The particular family of PSWFs utilized is determined in accordance with bandwidth and accuracy requirements.

### CROSS-REFERENCE TO RELATED APPLICATIONS

The present application claims priority from a co-pending U.S. Provisional Patent Application, Ser. No. 60/481,771, filed Dec. 11, 2003, and incorporated herein by reference in its entirety.

### STATEMENT REGARDING FEDERALLY-SPONSORED RESEARCH AND DEVELOPMENT

Certain aspects of the present invention were derived from Federally-sponsored research under DARPA grants F49620-98-1-0491 and F30602-98-1-0154. Consequently, the United States Government may have certain rights in the present invention.

### TECHNICAL FIELD

The present invention relates generally to signal processing, and in particular, to the interpolation and approximation of functions representing bandlimited physical measurements.

### BACKGROUND ART

In a spectrum of very diverse industries, data sequences are recorded and users of these data wish to approximate the underlying functions at points other than the data recording points. Some examples of data acquired/recorded include but are not limited to seismic data, gravity data, magnetic data, digital and scanned images, moving pictures, etc. Typically the data sequences are sampled at equally spaced nodes like in the case of digital images and the typical methods used currently for approximating/interpolating these data sequences are based on the Fourier and/or on polynomial and/or spline interpolation.

There are two problems with using the Fourier and/or polynomial and/or spline interpolation for approximating non-periodic data. First, the approximation at the edges of the data is of poorer quality than that in the middle. Second, the number of nodes necessary for a quality approximation is larger than is minimally possible.

One particular field in which large, complex data sequences are collected is that of seismology. Almost all geophysical exploration, and in particular hydrocarbon exploration, includes the use of seismic methods. Seismic exploration generally begins with a seismic data acquisition in an area that has been identified as promising for hydrocarbon exploration. Seismic data acquisition surveys use acoustic sources (generally referred to as “shots”) as a source of seismic waves. Those seismic waves propagate radially through the ground in accordance with the acoustic impedance (analogous to electrical impedance in electric circuit theory) of the geologic layer(s) through which the waves travel. For example, in FIG. 1, point S represents the location of such an acoustic source with respect to a vertical cross-section of ground showing two geologic layers or “strata” 100 and 102. Line 104 represents the direction of travel for a point on the radiating seismic wavefront generated by the source at S. Point R lies on the interface between two geologic layers having different acoustic impedances. According to basic principles of physics, when a wavefront comes into contact with the interface between two media of different impedances (i.e., an impedance “mismatch”), at least a portion of the wave energy is reflected back from the interface in the general direction of the source. Generally speaking, a portion of the wave energy will also be transmitted across the interface, although the direction of the transmitted wavefront may change. This change in direction is known as diffraction. Well-understood physical laws, such as Snell's law, govern the velocity and direction of these reflected and refracted waves. Thus, because the velocity and direction of incident and reflected or refracted waves can be determined mathematically, it is possible to identify the locations of acoustic impedance mismatches by measuring the amount of time it takes for a reflected/refracted wave to reach an observation point on the surface.

For example, in FIG. 1, an incident wavefront travelling in the direction of line 104 will reach the interface between layer 100 and layer 102 at point R, at which point the impedance mismatch between layer 100 and layer 102 causes a reflection of the wave to travel in the direction of line 106 to point D (the detection point) where the arrival time of the reflected wave can be measured. Since the velocity and direction of travel of the incident and reflected wave can be determined mathematically, the depth of point R, as measured from the surface can be determined from the arrival time of the reflected wave. This process is known as reflection seismography, and it provides information about the locations, shapes, and material compositions of various geologic features. Knowledge of these features may be used for locating hydrocarbons or other mineral resources, as well as for other uses, such as determining the geologic structure of a particular site for civil engineering purposes, for example. Another application for this general type of technology is in the medical field, where ultrasonic acoustic waves are used in a similar fashion to perform medical imaging (e.g., sonograms).

Returning now to the problem of geophysical exploration, however, it is customary to employ multiple seismic detectors at different points will be used in conjunction with a single acoustic source, to allow seismic data to be obtained over a broad area. Different types of acoustic sources are used in different arrangements, depending on the environment in question. Typically in onshore areas, “Vibroseis” acoustic sources are used to transmit seismic waves on the subsurface, which are transmitted and reflected off several subterranean layers, and eventually a portion of the originally transmitted energy is reflected back towards the earth's surface and received at detectors (receivers), which are spaced at predetermined spatial positions as to minimize the acquisition cost and increase the seismic data acquisition survey resolution. For offshore areas, the seismic vessel performing the seismic data acquisition uses airguns or waterguns which generate a significant pressure wave which propagates in the subsurface. The reflected seismic energy travelling back from the subsurface towards the ocean bottom is either received at receiver streamer cables towed by the seismic vessel or by ocean-bottom receivers placed by oil and gas companies.

Seismic survey data can also be categorized by the dimensionality of the data. “Two-dimensional” seismic data is obtained by placing the detectors in a single line. The information obtained in a two-dimensional survey provides the same type of visual perspective as FIG. 1, where the two dimensions are linear position along the line of detectors (horizontal) and depth (vertical, plotted downward). One of ordinary skill in the art will recognize that the depth coordinate is interchangeable with time, since the arrival time of a reflected wave determines the depth of the reflector. Mathematically speaking, two-dimensional seismic data is represented as two-dimensional scalar field, where the scalar value represents a magnitude of the seismic signal received at a particular surface position at a particular time.

“Three-dimensional” seismic data is obtained by arranging the detectors over a two-dimensional area on the surface. Usually, the detectors are arranged in some form of grid. A set of three-dimensional seismic data is a three-dimensional scalar field that represents a magnitude of the seismic signal received at a particular surface position at a particular time. During seismic data acquisition, the data are typically recorded in digital media, and their sheer volume, particularly in the case of a three-dimensional survey, can easily exceed several terabytes (1×10¹² bytes).

After the raw seismic data is obtained, it is then processed to extract useful information, typically in a graphic format. A variety of seismic data processing algorithms have been developed over the years. These algorithms take into account the seismic source and receiver positions, estimate the acoustic/elastic constants of the subsurface, and finally “migrate” the data, meaning that they identify the proper locations of the subsurface reflectors (i.e., the geologic features that cause the reflection of seismic waves).

Another area of technology in which interpolation and function approximation are of particular benefit is in image processing, where images from cameras, radiological equipment, and other image sources are used.

What is needed, therefore, is a method and apparatus for efficiently interpolating, analyzing, and representing non-periodic data, such as seismic measurements or other forms of images or image-like data (such as images from cameras or from medical equipment). The present invention provides a solution to this and other problems, and offers other advantages over previous solutions.

### SUMMARY OF THE INVENTION

A preferred embodiment of the present invention provides a method and apparatus for performing efficient interpolation of data sequences or signals. A preferred embodiment of the present invention utilizes generalized Gaussian quadratures using various orthogonal bases of bandlimited functions that are well-suited to approximating bandlimited functions. A preferred embodiment of the present invention, unlike previous methods, provides a high quality approximation at the edges while at the same time using the minimal number of nodes for the approximation. The present invention has application in a number of different industries and with regard to different types of data, since it provides a computationally efficient data approximation/interpolation for general type of non-periodic non-equally spaced bandlimited data with no additional assumptions. Areas in which the present invention has particular value include seismic data acquisition and data processing and image processing and presentation.

A preferred embodiment of the present invention determines a suitable Gaussian quadrature to match given bandwidth and accuracy requirements. This Gaussian quadrature is then used to construct a suitable family of interpolating functions to represent a physical data sequence or signal (which, in a preferred embodiment, is seismic data). In one embodiment, Gaussian quadratures are constructed using trigonometric moments of exponential functions. In an alternative embodiment, an interpolating function is constructed using prolate spheroidal wave functions (PSWFs) by adopting Gaussian quadrature points corresponding to a family of PSWFs as interpolation points. The particular family of PSWFs utilized is determined in accordance with bandwidth and accuracy requirements.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF DRAWINGS

The present invention may be better understood, and its numerous objects, features, and advantages made apparent to those skilled in the art by referencing the accompanying drawings, wherein:

FIG. 1 is a diagram illustrating a process of reflection seismography;

FIG. 2 is a diagram depicting a marine seismographic survey vessel provided as an example of an overall data acquisition and processing system constructed in accordance with a preferred embodiment of the present invention;

FIG. 3 is a flowchart representation of an overall process of acquiring and interpolating physical data or signals in accordance with a preferred embodiment of the present invention;

FIG. 4 is a flowchart representation of a process of a generating an interpolating function for a given set of data by way of a generalized Gaussian quadrature over complex exponential functions in accordance with a preferred embodiment of the present invention;

FIG. 5 is a flowchart representation of a process of a generating an interpolating function for a given set of data by way of a generalized Gaussian quadrature over prolate spheroidal wave functions in accordance with a preferred embodiment of the present invention;

FIG. 6 is a flowchart representation of a process of evaluating a prolate spheroidal wave function for the purpose of generating an interpolating function in accordance with a preferred embodiment of the present invention;

FIG. 7 is a block diagram of a data processing system in which a preferred embodiment of the present invention may be implemented.

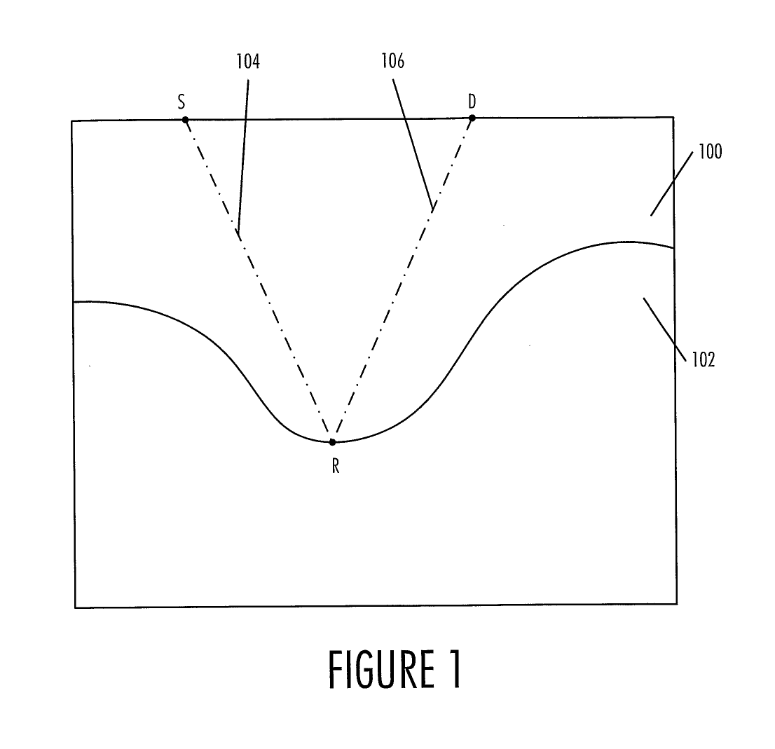

### DETAILED DESCRIPTION

The following is intended to provide a detailed description of an example of the invention and should not be taken to be limiting of the invention itself. Rather, any number of variations may fall within the scope of the invention, which is defined in the claims following the description.

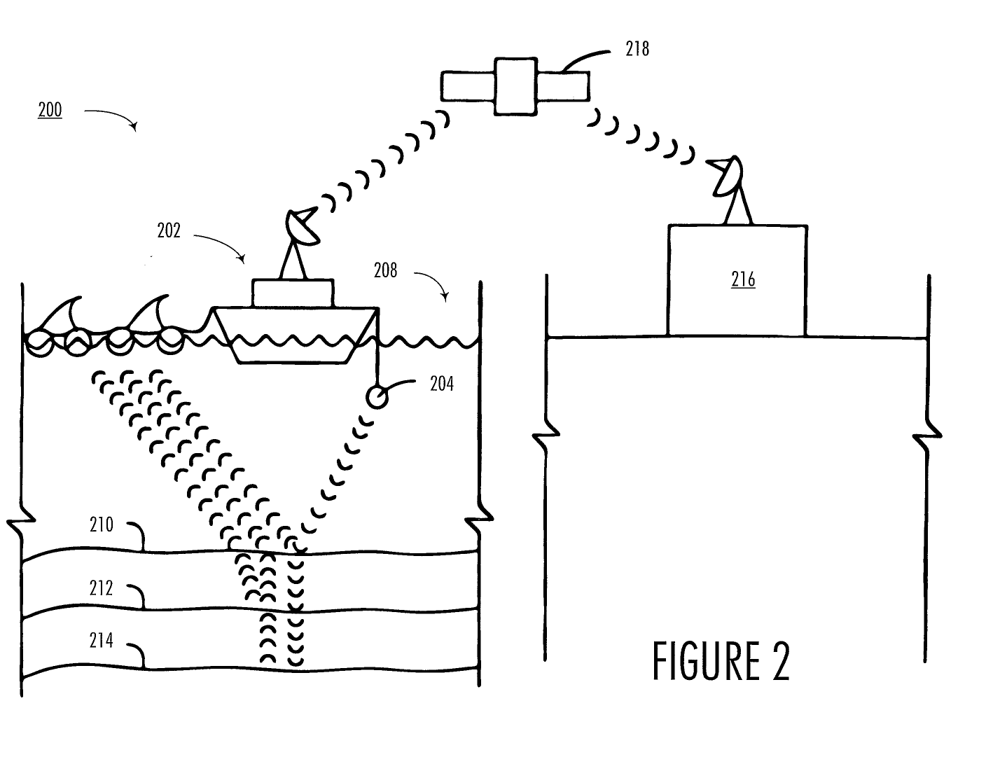

Referring now to the drawings, FIG. 2 provides a schematic representation of an oceanic seismic survey system 200 of the type used to obtain seismic data which can be processed in accordance with preferred embodiments of the present invention. System 200 includes the use of a seismic vessel 202 having an acoustic wave source 204 and a towed array of spaced-apart receivers 206. For example, the towed array can comprise a total of four to eight streamer cables which are towed in parallel behind the vessel 202, with each cable having a large number (such as 240) of floatable receivers 206, which are serially attached to the cable.

During operation, vessel 202 transverses the surface of an ocean 208 in a regular pattern while periodically directing acoustic wave energy (referred to as “shots”) downwardly from source 204. The wave energy is reflected back to receivers 206 at an ocean floor boundary 210, as well as at subterranean boundaries (such as boundaries 212 and 214). The signals detected by receivers 206 are converted to digital form and stored in computerized data storage equipment (not shown) aboard vessel 202. It is common to subsequently transmit the resulting data sets to a land-based processing center 216 using a suitable system, such as a satellite communication system 218. In a preferred embodiment of the present invention, processing center 216 utilizes a computer or other data processing apparatus, such as that described in FIG. 7 for example, to process and/or analyze the data received.

The seismic data sets can be manipulated to produce three dimensional representations (images) of the resulting subterranean features, enabling decisions with regard to the desirability of further exploring a given location for oil and gas deposits. Because the seismic data are arranged in two spatial dimensions and one time dimension, as well as on a per shot basis, seismic data sets can quickly reach several tens of terabytes (10¹² bytes) in size. Thus, to allow near real-time reporting of the seismic data sets to processing center 216 (while vessel 202 is still on location), the data are typically compressed and a compressed data set are transmitted via the satellite communication system 218. At this point it will be noted that present invention can be utilized in other environments as well, such as in an onshore exploration setting. Hence, the discussion of the environment of FIG. 2 has been provided merely for purposes of illustration, and is not limiting.

An objective of this invention is to provide an acquisition, processing, and data presentation system that has a minimal number of nodes for given bandwidth and accuracy of the measured data. If the measured data were periodic, then the optimal distribution of nodes is that of equally spaced nodes, where the minimal number of nodes is given by the Nyquist criterion. Specifically, it is sufficient to have two nodes per highest wavelength (wavenumber) that we want to measure and process.

Since data periodicity rarely occurs in the real world, periodicity is, in practice, enforced by applying smooth windows on the edges of the data, thus reducing the useable portion of the data. Alternatively, one can use polynomial based interpolation which require sampling at rates higher (by at least a factor of two in practical applications) than the Nyquist criterion.

The present invention provides a method and apparatus for optimal data acquisition, processing, and presentation using the generalized Gaussian nodes for bandlimited exponentials. These generalized Gaussian nodes and the corresponding weights are constructed in accordance with given bandwidth and accuracy requirements of measurements or processing. It can be shown that in this method the sampling rate for non-periodic data approaches the Nyquist sampling rate for the periodic data, namely 2 nodes per wavelength, as the number of nodes becomes large. This sampling rate is optimal for a given bandwidth and accuracy.

The present invention utilizes advantageous properties of Gaussian quadratures to perform highly accurate interpolation of data sequences or signals with the lowest required sampling rate. All practical physical signals are bandlimited, in that they contain a limited spectrum of frequencies. For example, the human ear can only detect frequencies up to about 22 kHz. Thus, audio signals have a limited frequency spectrum or bandwidth. Similarly, radio and other telecommunications signals are bandlimited. In formal mathematical notation, a function f is said to be bandlimited if it can be represented as the truncated Fourier integral

$$f ( y ) = \frac{1}{\sqrt{2 π}} {\int }_{- c}^{c} F ( ω ) {ⅇ}^{- ⅈ ω y} ⅆ ω .$$

By way of a simple change of variable, this expression may be rewritten as

$$f ( y ) = \frac{c}{\sqrt{2 π}} {\int }_{- 1}^{1} F ( c ω ) {ⅇ}^{ⅈ c ω y} ⅆ ω .$$

As both of these expressions show, a bandlimited function can be expressed in terms of an integral over a finite interval.

Quadrature formulas are typically used to evaluate definite integrals numerically by computer. To evaluate an integral of a function using a quadrature formula, the function is evaluated at a set of points (known as nodes). Each of these function evaluations is multiplied by a particular coefficient (referred to as a weight), and the corresponding products are added together to obtain the result. These quadrature formulas are generally based on some kind of interpolation or approximation to the actual function, so that the result of the quadrature formula is actually the integral over a finite integral of some approximation to the actual function.

Gaussian quadratures are one particular type of quadrature formula in which the nodes are carefully chosen to produce the most accurate result with the minimal number of nodes. In particular, Gaussian quadratures are based on the construction of certain functions that form orthogonal bases for vector spaces. The most commonly encountered type of Gaussian quadrature utilizes Legendre polynomials as its basis functions. Where polynomials of degree n are used as the basis functions for a Gaussian quadrature, the resulting quadrature formula yields an exact integration result when integrating over polynomials of degree up to 2n+1. Other families of generalized Gaussian quadratures (generalized Gaussian quadratures) exist and have similar abilities to integrate certain families of functions in an optimal manner (relative to the order of the quadrature itself exactly.

Preferred embodiments of the present invention recognize two constructions of such Gaussian quadratures, one based on trigonometric moments of exponential functions and another utilizing prolate spheroidal wave functions. The bandwidth and accuracy of these Gaussian quadratures are selected in their construction. Thus, a bandlimited function (which, as the reader will recall, can be expressed as an integral over a finite interval) can be approximated with the nodes and weights of such Gaussian quadratures.

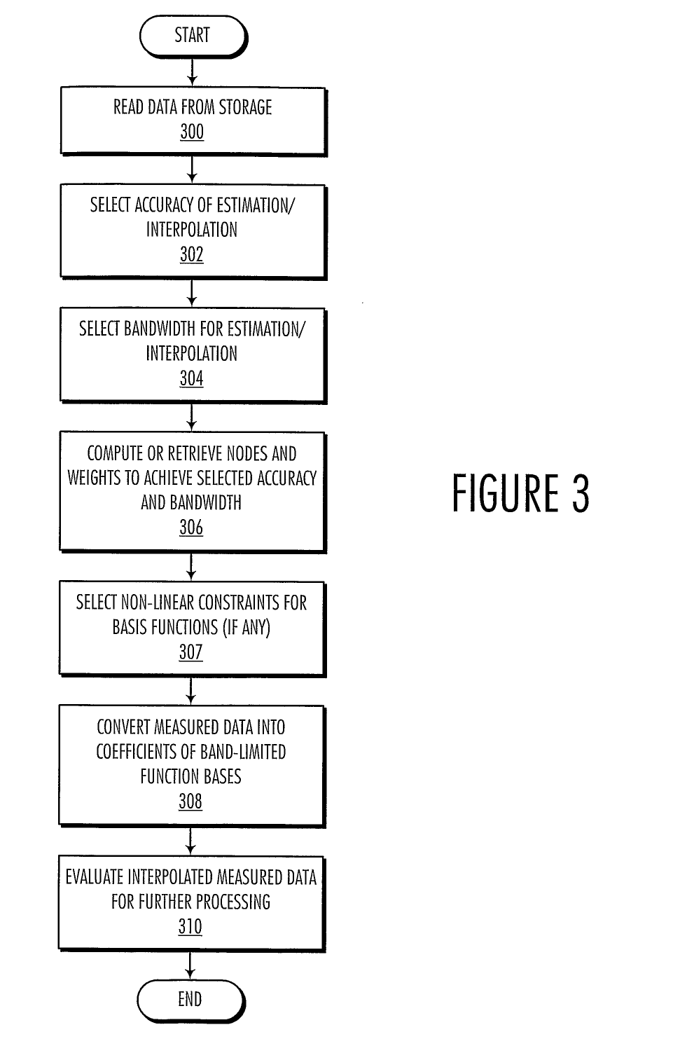

A preferred embodiment of the present invention takes advantage of the benefits of generalized Gaussian quadratures for bandlimited functions by employing a process described generally in flowchart form in FIG. 3. This process takes a sequence of data samples and generates a family of continuous interpolating functions that very closely approximate the physical phenomena measured by the data samples. A sequence of discrete data samples representing a bandlimited signal, such as seismic trace measurements, is read from storage or from real-time physical measurements or signals (block 300). An acceptable level of accuracy for the interpolation/estimation is selected (block 302). An appropriate bandwidth for the bandlimited signal is also selected (block 304). The level of accuracy and bandwidth are used to determine the order of a Gaussian quadrature to be utilized for the interpolation, and the nodes and weights for such quadrature are computed or retrieved in pre-computed form from memory or other data storage (block 306).

One advantage of using generalized Gaussian quadratures selected for a desired accuracy and bandwidth is that only a very few of the basis functions can contribute to any possible ill-conditioning of the system of equations needed to be solved for the estimation problem. In fact the number of such functions is proportional only to the logarithm of c, where c is the bandlimit. This makes it possible to impose non-linear constraints for the system of equations constructed for solving the estimation problem. (block 307). One such possible nonlinear constraint is to remove from consideration those basis functions that correspond to small eigenvalues in their construction. Alternative, more-sophisticated non-linear constraints can be used as well.

The nodes, weights, and selected non-linear constraints are then used to generate a family of interpolating functions for the data that is a linear combination of bandlimited function bases with appropriate coefficients (block 308). Finally, the interpolating function is evaluated to obtain values used in any further processing (block 310).

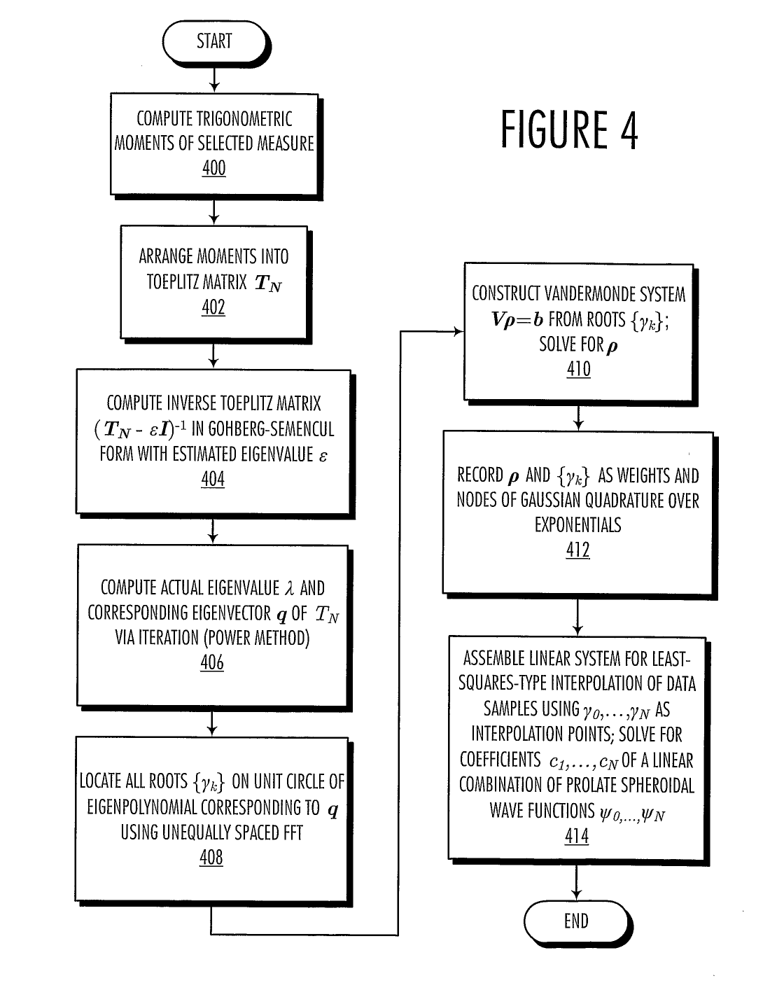

FIG. 4 is a flowchart representation of a process of generating a family of interpolating functions based on generalized Gaussian quadratures constructed using trigonometric moments of exponential functions. First (block 400), a measure function w having support over the interval [−0.5, 0.5] is chosen and N+1 trigonometric moments of that weight function are computed as

$${t}_{k} = {\int }_{- 1}^{1} {ⅇ}^{ⅈ π τ k} ω ( τ ) ⅆ τ$$

where 0≦k≦N and where N is selected to be sufficiently high to achieve a desired level of accuracy at a given bandwidth requirement.

Next (block 402), the computed moments are arranged into an N+1×N+1 Toeplitz matrix T_{N} as follows
T_{N}{tₗ₋ₖ}_{0≦k,l≦N}
where, for negative subscripts of t, t₋ₖ=tₖ. Then, an inverse matrix is calculated using an estimated eigenvalue ε, where ε is also a measure of the desired level of accuracy (block 404). The inverse matrix is calculated as
(T_{N}−εI)⁻¹
where the capital I represents the identity matrix. This inverse matrix is preferably computed in Gohberg-Semencul form to improve the efficiency of subsequent calculations.

The power method is then applied to the inverse matrix in order to compute an actual eigenvalue λ for T_{N} and its corresponding eigenvector q (block 406). Due to the way in which the power method works, the eigenvalue λ that is obtained will be an eigenvalue that is relatively close to the original estimated eigenvalue ε. The q eigenvector so obtained is then used to create an “eigenpolynomial” P by making the elements of q the coefficients of the polynomial so that

$$P = {\sum }_{k = 0}^{N} {q}_{k} {x}^{k} .$$

The set {yₖ} of all roots of P lying on the unit circle (in the complex number plane) is then determined (block 408). In a preferred embodiment of the present invention, the Unequally-Spaced Fast Fourier Transform (USFFT) is used to evaluate P at points lying on the unit circle so as to locate the desired roots. The set {yₖ} represents the locations of the Gaussian nodes.

A linear system of equations is then constructed using the located roots to build a Vandermonde matrix V and the original trigonometric moments to construct a vector b such that
Vρ=b
where ρ represents the weights of the Gaussian quadrature (block 410), such that when the system is solved, the nodes and weights of the Gaussian quadrature so obtained are within the vectors {yₖ} and ρ, respectively (block 412). A least-sqaures-type interpolation is then performed using the Gaussian quadrature nodes {yₖ} as the interpolation points and using a family of orthogonal bandlimited functions, such as the prolate spheroidal wave functions, as the basis functions for the interpolation (block 414). The prolate spheroidal wave functions and a method for their evaluation is provided in XIAO, H., et al.. Prolate spheroidal wavefunctions, quadrature and interpolation. Inverse Problems. 2001, vol. 17, no. 4, p. 805-838., which is incorporated herein by reference. Because the Gaussian quadrature nodes are used as the interpolation points, an optimal degree of accuracy is achieved at the bandwidth in question.

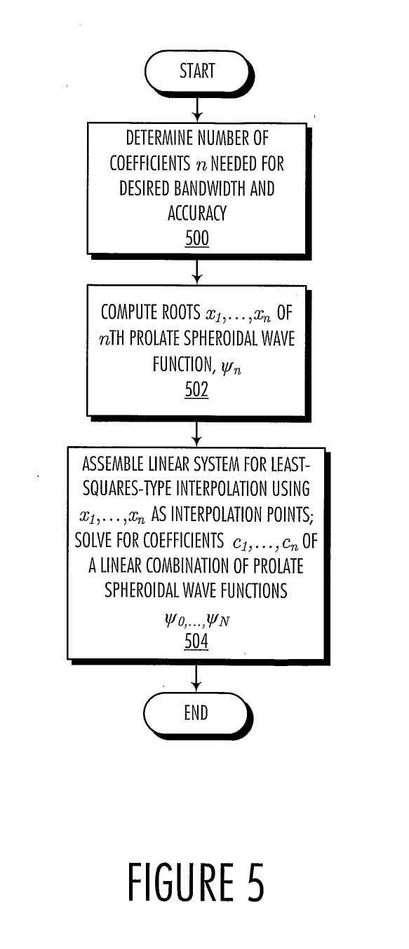

FIG. 5 is a flowchart representation of a process of generating a family of interpolating functions based on generalized Gaussian quadratures constructed using prolate spheroidal wave functions (PSWFs). First, a number n of coefficients of PSWFs to be utilized in the estimation is chosen (block 500). Next, the highest order function of a family of n PSWFs (that is, ψₙ) for the estimation is computed and the roots (x₁, . . . , xₙ) of ψₙ are calculated (block 502). These roots are the nodes of a generalized Gaussian quadrature. Finally, a least-sqaures-type interpolation is performed using the obtained Gaussian quadrature nodes (x₁, . . . , xₙ) as the interpolation points and using the aforementioned family of prolate spheroidal wave functions (ψ₁, . . . , ψₙ), as the basis functions for the interpolation (block 504).

The present invention provides numerous benefits in a wide variety of applications. The present invention optimizes acquisition geometries, minimizes the cost of surveys, and maximizes the bandwidth and the useful aperture of the collected data. Also, this invention prepares data for further processing or data presentation by resampling said data at desired locations with complete accuracy control.

Also, this invention makes possible rendering and/or displaying of data on the computer screens, and/or on paper and/or via any other media of rendering and/or displaying data, as well as zooming while rendering and/or displaying data on the computer screen, and/or on paper and/or via any other media of rendering and/or displaying data, without pixelization of said zoomed, rendered or displayed data, by resampling the data at desired locations with a full accuracy control.

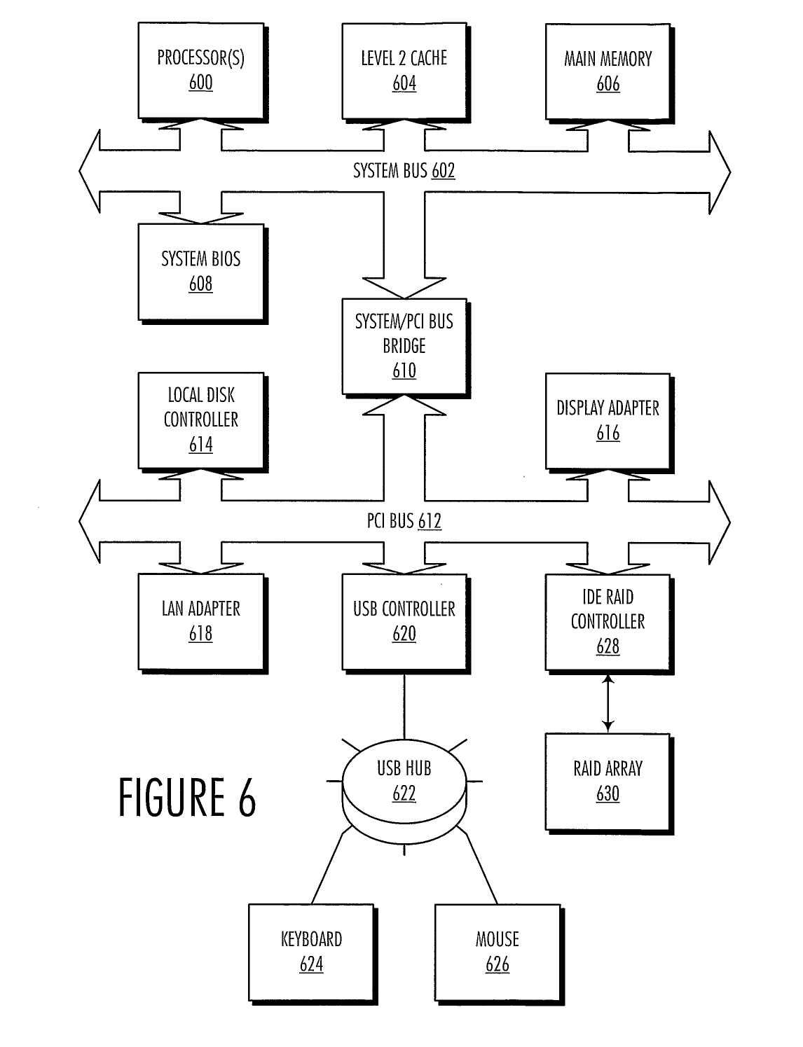

FIG. 6 is a block diagram of a computer system in which a preferred embodiment of the present invention may be implemented. One or more processors 600 are coupled to a system bus 602, which connects processor(s) 600 to various memory components. Main memory 606, comprising Random Access Memory (RAM), represents the bulk of primary memory storage available to processor(s) 600. A level 2 cache memory 604, which is smaller than main memory 606 but constructed using faster memory components than main memory 606, is a temporary intermediate storage area that allows processor(s) 600 to operate at a higher speed than would otherwise be possible with only main memory 606. System BIOS 608, a non-volatile memory, contains system firmware for loading an operating system at system startup and for performing various other low-level functions. BIOS is an acronym for “Basic Input/Output System.” For performance purposes, it is common for processor(s) 600 to copy the contents of BIOS 608 into main memory 606 for faster access, as RAM generally allows faster access than non-volatile memories; this copying is referred to as “shadowing.”

Typically, system bus 602 will follow a proprietary specification associated with processor(s) 600. While this arrangement is acceptable for interfacing processor(s) 600 to memory, because it provides for maximum performance, the proprietary nature of most microprocessor bus signal specifications seriously limits the ability of system buses like bus 602 to interface with off-the-shelf peripheral devices. For that reason, it is customary in computer design to include one or more backplane buses following a standard bus specification, to allow third-party peripheral devices to be connected to the computer system. In FIG. 6, a bus 612 following the Peripheral Component Interconnect (PCI) industry standard is provided for the connection of various peripherals. A system/PCI bus bridge 610 connects system bus 602 to PCI bus 612 and translates bus signals between the two buses.

A number of peripheral devices are shown connected to PCI bus 612. One of ordinary skill in the art will recognize that any of a great number of different kinds of devices may be connected to such a bus and that the devices described here as connected to bus 612 are intended to be merely examples. A local disk controller 614 allows data to be read or written to a locally-attached disk device such as a fixed-disk drive or a removable-disk drive. A display adapter 616 provides an interface between PCI bus 612 and a display device, such as a cathode-ray tube (CRT), liquid crystal display (LCD), or plasma display device. Local area network (LAN) adapter 618 connects PCI bus 612 to an Ethernet, 802.11 wireless network, or other form of local area network infrastructure. An IDE (Integrated Drive Electronics) controller 628 to a RAID array (Redundant Array of Inexpensive Disks) 630 is provided. RAID array 630 provides efficient, reliable mass storage of data through an array of individual disk drives working in cooperation with each other to provide rapid throughput and error detection/correction capabilities.

Universal Serial Bus (USB) controller 620 provides an interface between PCI bus 612 and USB hub 622, to which peripheral devices conforming with the USB interface standard may be attached. USB devices are generally “hot-swappable,” meaning that they may be safely added or removed from the system while the system is turned on. USB devices are typically used in applications where a removable or external device is desirable, such as in the case of human input devices. For example, in the computer system depicted in FIG. 6, USB keyboard 624 and USB mouse 626 are shown connected to USB hub 622.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an;” the same holds true for the use in the claims of definite articles.

1. A computer-implemented method comprising:
obtaining a set of data samples representing an image;
generating a set of nodes in a generalized Gaussian quadrature; and
performing an interpolation of the data samples using the nodes as interpolation points, wherein the interpolation is defined as a linear combination of a family of bandlimited orthogonal basis functions.

2. The method of claim 1, wherein the generalized Gaussian quadrature is selected in accordance with an accuracy requirement.

3. The method of claim 2, wherein a bandwidth of the generalized Gaussian quadrature is selected so as to optimize accuracy of the interpolation.

4. The method of claim 3, wherein the Gaussian quadrature is selected to have a number of nodes that optimizes accuracy of the interpolation.

5. The method of claim 1, wherein the family of bandlimited orthogonal basis functions includes a plurality of prolate spheroidal wave functions.

6. The method of claim 5, wherein the plurality of prolate spheroidal wave function includes at least one of an exact prolate spheroidal wave function and an approximate prolate spheroidal wave function.

7. The method of claim 1, wherein the generalized Gaussian quadrature is a generalized Gaussian quadrature for exponentials.

8. The method of claim 1, wherein the set of nodes in the generalized Gaussian quadrature is computed from zeros of a prolate spheroidal wave function.

9. The method of claim 1, wherein the image represents seismic measurements.

10. The method of claim 1, wherein the image is derived from medical imaging apparatus.

11. The method of claim 1, wherein the image is obtained from a camera.

12. The method of claim 1, wherein the data samples are arranged in proximity to nodes of a generalized Gaussian quadrature for exponentials.

13. A computer-implemented method comprising:
obtaining a set of data samples representing one or more physical measurements;
generating a set of nodes in a generalized Gaussian quadrature, wherein the generalized Gaussian quadrature is selected in accordance with given accuracy and bandwidth requirements; and
performing an interpolation of the data samples using the nodes as interpolation points, wherein the interpolation is defined as a linear combination of a family of bandlimited orthogonal basis functions.

14. The method of claim 13, wherein the physical measurements include seismic data.

15. The method of claim 13, wherein individual ones of the data samples are spatially related to other data samples according to a particular geometry.

16. The method of claim 15, wherein the geometry corresponds to a surface.

17. The method of claim 15, wherein the geometry corresponds to a path.

18. The method of claim 15, wherein the geometry is irregular.

19. The method of claim 13, wherein individual ones of the data samples are temporally related to other data samples.

20. A computer-implemented method comprising:
obtaining a set of data samples representing a signal;
generating a set of nodes in a generalized Gaussian quadrature, wherein the generalized Gaussian quadrature is selected in accordance with given accuracy and bandwidth requirements; and
performing an interpolation of the data samples using the nodes as interpolation points, wherein the interpolation is defined as a linear combination of a family of bandlimited orthogonal basis functions.

21. The method of claim 20, wherein the data samples have been sampled at a sampling rate that is less than a corresponding Nyquist rate for the signal.

22. The method of claim 21, wherein the data samples are aliased.
